(19) United States
(12) Patent Application Publication
(10) Pub. No.: US 2017/0282427 A1
(43) Pub. Date: Oct. 5, 2017

(54) METHOD OF MULTI-CAVITY INJECTION MOLDING AND MOLD

(71) Applicant: Fantec Co., Ltd., Sano-shi, Tochigi (JP)

(72) Inventor: Hiroyuki OHNO, Sano-Shi, Tochigi (JP)

(73) Assignee: Fantec Co., Ltd., Sano-shi, Tochigi (JP)

(21) Appl. No.: 15/507,331

(22) PCT Filed: Nov. 25, 2014
(86) PCT No.: PCT/JP2014/081121

§ 371 Date: Feb. 28, 2017

(51) Int. Cl. B29C 45/18; B29C 45/27

(52) U.S. Cl. CPC B29C 45/18; B29C 45/2737; B29C 45/27; B29C 2045/2753

(57) ABSTRACT

Disclosed is a technology for eliminating the need for the adjustment of imbalance in an injection molded product and also enabling multi-cavity molding, a method of multi-cavity injection molding including: a dividing step of dividing a molten resin material into a plurality of portions; a resin density adjustment step of adjusting a resin density distribution; and a filling step of filling the molten resin material into a region where the molten resin material is formed into a molded product. The method of multi-cavity injection molding has a configuration containing a combined-use step which includes both a hot runner step and a cold runner step. The combined-use step is dividing the molten resin material from the hot runner to the plurality of cold runners through a spool and a branch runner. A plurality of series of steps from the dividing step to the filling step is concurrently performed in one mold.

### CROSS-REFERENCE TO RELATED APPLICATION

This application is the U.S. National Phase of International Patent Application No. PCT/JP2014/081121, filed on Nov. 25, 2014, the contents of which are incorporated herein in it's entirety.

### TECHNICAL FIELD

The present invention relates to a technology for producing a resin product which rotates at high speed, such as a sirocco fan and a turbofan, by an injection molding unit. Specifically, the present invention relates to a technology for an injection molding method and a mold which eliminate the need for the adjustment of imbalance of the injection molded product and which have uniform density properties. In addition, the present invention relates to a technology for an injection molding method and a mold which balance between uniform density properties and multi-cavity molding by applying a combination of the temperature adjustment by a hot runner and the pressure adjustment by a cold runner to control the fluidity of molten resin for enabling multi-cavity molding.

### BACKGROUND

When multi-cavity molding is achieved in injection molding, the manufacturing time can be drastically reduced, and therefore, the merits thereof are great. However, the multi-cavity molding causes the number and length of runners which link a plurality of cavities to increase. This sometimes raises problems such as distortion attributable to viscosity changes and anisotropic properties due to temperature variations in a flow channel. Furthermore, harmful effects attributable to residual stress are sometimes caused. Therefore, multi-cavity molding is generally not employed for injection molded products which are required to be balanced at high rotations, such as a blast fan, from the viewpoint of the distribution management of resin density, the design of runners, and the like.

When attention is directed to such a runner design, a hot runner, which enables fluidity to increase so that the quality of the molded product is improved, has been often employed in recent years. With the hot runner, heating can be performed immediately before a cavity even when the runner is long. Therefore, occurrences of “insufficient filling (short shot)” and “weld marks” can be prevented even in a narrow flow channel such as a blade portion. Also, since only a molded product can be removed, the process of pulverizing an unnecessary runner and the process for reuse are not required. Therefore, the use of the hot runner contributes to environmental preservation and reduced waste plastic. Furthermore, there is a merit, for example, in that commercialization abilities are substantially increased.

On the other hand, there is also a problem in that the management of temperature becomes difficult. For example, the excessively high temperature of molten resin results in brittleness due to thermal degradation. Also, as already known, when molten resin flows at high speed through a narrow portion like a blade portion, molecules constituting the resin are stretched in the flow direction, causing the phenomenon of “flow orientation” or “molecular orientation” in which the molecules are arranged in the flow direction. Thus, such a flow rate needs to be adjusted, in an injection molded product, such as a blast fan, which is required not to cause vibration during low rotations to high rotations. Such adjustment influences determination on whether or not the adjustment of imbalance is necessary.

As described above, in the current situation, multi-cavity injection molding is difficult to be performed for producing a high-accuracy, high-quality injection molded product, which is required not to cause noise and vibration, of a high-rotation product such as a sirocco fan, a turbofan, and a blower. It can be said that the technology for achieving multi-cavity molding for a high-accuracy, high-balance fan is demanded. A predetermined balance is important in a product which rotates at high speed, such as a fan and a blower. Furthermore, in the cavity for the product, various conditions such as the flow rate, temperature and pressure of molten resin are necessary to be uniform.

Also, when the temperature of resin is excessively increased in an attempt to obtain good fluidity for multi-cavity molding, there is a problem in that the resin becomes brittle due to the thermal degradation of resin. Furthermore, non-uniform fluidity also causes vibration and noise. Thus, multi-cavity molding has many problems. Therefore, when multi-cavity molding is achieved, there are great merits in that the cost can be reduced, and the manufacturing time can be shortened.

It is noted that Computer Aided Engineering (CAE) which computer-analyzes the flow state in plastic molding processing is being developed in recent years. However, injection molding is the process of allowing molten resin to flow through a cold mold at high speed and solidifying the molten resin under high pressure. Therefore, molding behavior is extraordinarily complicated. Especially, the flow state of an injection molded product having a thin and long blade portion such as a blast fan is difficult to be analyzed.

In view of such a current state, various technologies have been proposed. For example, the technology of providing a “synthetic resin injection molding mold which does not cause problems such as minute sink marks appearing on the surface of a molded product, hesitation in the middle of injection, and generation of excessive pressure in the end of injection” has been proposed, and comes to be publicly known (see, for example, Japanese Unexamined Patent Application Publication No. 2002-210795). More specifically, “the surface of the cavity of the synthetic resin injection molding mold is alternately heated and cooled. A resin supply channel of the synthetic resin injection molding mold is a cold runner system or a semi-hot runner system. A heating and cooling medium flow channel disposed to at least portion of the resin supply channel alternately heats and cools the resin supply channel. It is noted that the mold may include an adiabatic layer on at least portion of the resin supply channel, instead of alternately heating and cooling at least portion of the resin supply channel.”

Also, the technology of “providing an injection molding apparatus including a simple mold which can quickly and easily change the shape of a cavity according to the shape of a molded product and which can sufficiently satisfy requirements concerning small-lot productions, shortened delivery times and lowered costs” has been proposed, and comes to be publicly known (see, for example, Japanese Unexamined Patent Application Publication No. 2004-209904). More specifically, “the injection molding apparatus includes: a simple mold which has an exchange portion disposed with a cavity and a fixed portion to be fixed to an apparatus body; and a control portion that controls the action of opening and closing the simple mold. The exchange portion includes a fixed-type plate to be fixed to the fixed portion, a movable-type plate which approaches and separates from the fixed-type plate, and an extruding mechanism for allowing a molded product to separate. The fixed portion includes a hot runner for sending out molten resin in a molten state into a cavity. The fixed-type plate includes a cold runner for guiding the molten resin sent out from the hot runner into a cavity.” Such a technology is disclosed.

Also, the technology of “ensuring the fluidity of a molten resin material in a cold runner used together with a hot runner for inhibiting solidification of the resin material and previously preventing contamination of a molded product with a cold slug” has been proposed, and comes to be publicly known (see, for example, Japanese Unexamined Patent Application Publication No. 2012-187842). More specifically, a cold runner is disposed in series with a hot runner in such a manner that the hot runner is extended. The cold runner is constituted by a groove portion having a substantially semi-circular cross section formed on a split surface on a splitting block side, and a split surface on a cavity block side. An adiabatic layer is formed on the groove portion side so that the cold runner has adiabatic effects. The terminal portion of the cold runner serves as a slug well for trapping cold slugs. Accordingly, a non-adiabatic structure is formed to this slug well without disposing an adiabatic layer.

All of the above-described prior arts are the same as the solution to the problems of the present invention, in that the combined use of the cold runner and the hot runner enables improvement of the accuracy of a molded product. However, the problem of multi-cavity molding is not contained in the technologies according to Japanese Unexamined Patent Application Publication No. 2004-209904 and Japanese Unexamined Patent Application Publication No. 2012-187842. The problem of achieving multi-cavity molding while increasing accuracy is neither described nor suggested. Therefore, such a problem has not been solved yet. In Patent Document 3, multi-cavity molding is illustrated in FIG. 2. However, the multi-cavity molding in the drawing is merely a prior example of commonly used multi-cavity molding. Therefore, there is no description on the multi-cavity molding with a combined use of the hot runner and the cold runner.

### SUMMARY

The present invention has been achieved in view of the above-described problems. That is, the major feature of the present invention is that by paying attention to the combined use of a hot runner 150 and a cold runner 160, multi-cavity molding for a molded product which is required to have a high density distribution, which has been impossible, was enabled by highly accurate temperature management by the hot runner 150 and pressure and speed management by the cold runner 160.

In order to achieve the above object, the present invention is to provide a method of multi-cavity injection molding for enabling multi-cavity molding of injection molded products required to have sophisticated resin density distribution, including: a dividing step of dividing a molten resin material from an injection apparatus into a plurality of portions through a plurality of equal-length runners; a resin density adjustment step of adjusting a resin density distribution of the molten resin material divided into each portion in the dividing step; and a filling step of filling the molten resin material having a resin density which has been adjusted in the resin density adjustment step into a region where the molten resin material is formed into a molded product. The resin density adjustment step includes a combined-use step in which both a hot runner step of readjusting a temperature of the molten resin material to adjust fluidity and a cold runner step of adjusting pressure and speed are used in combination. The combined-use step is dividing the molten resin material from a hot runner to a plurality of the cold runners through a spool and a branch runner. A plurality of series of steps from the dividing step to the filling step is performed concurrently in one mold.

The present invention may also provide the method of multi-cavity injection molding configured such that a pin gate format in which a plurality of fillings of the molten resin material from the plurality of cold runners into the filling regions is arranged to be dispersed in a regular and evenly spaced manner is employed.

Moreover, the present invention is a mold for injection molding used in the method of multi-cavity injection molding, including: a dividing structure for dividing a molten resin material from an injection apparatus into a plurality of portions through a plurality of equal-length runners; a resin density adjustment structure for adjusting a resin density distribution of the molten resin material of each portion by division by the dividing structure; and a filling structure for filling the molten resin material having a resin density which has been adjusted by the resin density adjustment structure into a region where the molten resin material is formed into a molded product.

The method of multi-cavity injection molding may have a configuration in which resin flow paths from the dividing structure to the resin density adjustment structure are isometrically dispersed on the same pitch circle.

In the mold for multi-cavity injection molding, the resin density adjustment structure includes a combined-use runner structure in which both a hot runner for readjusting a temperature of the molten resin material to adjust fluidity and cold runners for adjusting pressure and speed are used in combination. The combined-use structure is for dividing the molten resin material from a hot runner to the cold runners through a spool and a branch runner. A plurality of series of structures from the dividing structure to the filling structure is provided in one mold, and the plurality of series of structures is concurrently operated

The present invention may also be the mold for multi-cavity injection molding configured such that a pin gate structure in which a plurality of fillings of the molten resin material from the cold runners into the filling regions is arranged to be dispersed in a regular and evenly spaced manner is employed.

The mold for multi-cavity injection molding may have a configuration in which resin flow paths from the dividing structure to the resin density adjustment structure are isometrically arranged on the same pitch circle.

The method of multi-cavity injection molding and the mold according to the present invention can eliminate the need for the adjustment of imbalance, and have uniform density properties. Furthermore, the method of multi-cavity injection molding and the mold each enables multi-cavity molding, and thus exerts the excellent effect that the production time is shortened.

Also, the method of multi-cavity injection molding and the mold according to the present invention have the excellent effect that the best state can be easily derived by adjusting the temperature of the hot runner nozzle and changing the channel inner diameter or throttle condition of the cold runner 160 according to individual shapes and dimensions, even in the molding of a shape for which the flow state of a molten resin material is difficult to be analyzed by the recently developed CAE, without relying on such an analysis technology.

Also, the injection molding method according to the present invention exerts the excellent effect that a fan which eliminates the need for balance adjustment can be manufactured. Also, since viscosity is decreased by heating, resin can penetrate deep into a narrow channel, thereby enabling creation of a fine shape such as a projection.

### BRIEF DESCRIPTION OF THE DRAWINGS

FIG. 1 is a flowchart illustrating steps of a method of multi-cavity injection molding according to the invention of the present application.

FIG. 2 is a front view illustrating a configuration for two-cavity molding according to the invention of the present application.

FIG. 3 is an enlarged front view for explaining the combined use of a hot runner and a cold runner.

FIG. 4 is a movable-side front view for two-cavity molding according to the invention of the present application.

FIG. 5 is a fixed-side bottom view for two-cavity molding according to the invention of the present application.

### DETAILED DESCRIPTION

The present invention includes both a hot runner 150 and a cold runner 160. Furthermore, the major feature of the present invention is that a plurality of runners having the same lengths is connected so that multi-cavity molding is possible while the accuracy is high.

Hereinafter, examples will be described based on the drawings. It is noted that the invention of the present application is not limited to the shape and dimension illustrated in the drawings. Modification is possible within the technical scope that can be said to be the main part of the creation of the technical idea indicated herein.

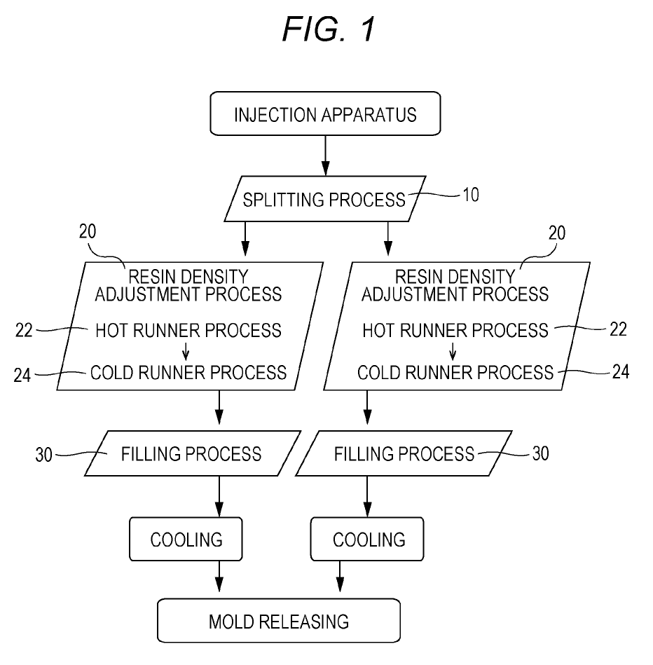

FIG. 1 is a flowchart illustrating steps used in the method of multi-cavity injection molding according to the present invention. The invention of the present application is an injection molding method that enables multi-cavity molding of a molded product required to have a uniform density distribution. Specifically, resin is needed to be filled in such a manner as to have uniform density for a molded product which rotates at high speed, such as a blast fan which rotates at several thousand revolutions per minute, such as a sirocco fan and a turbofan.

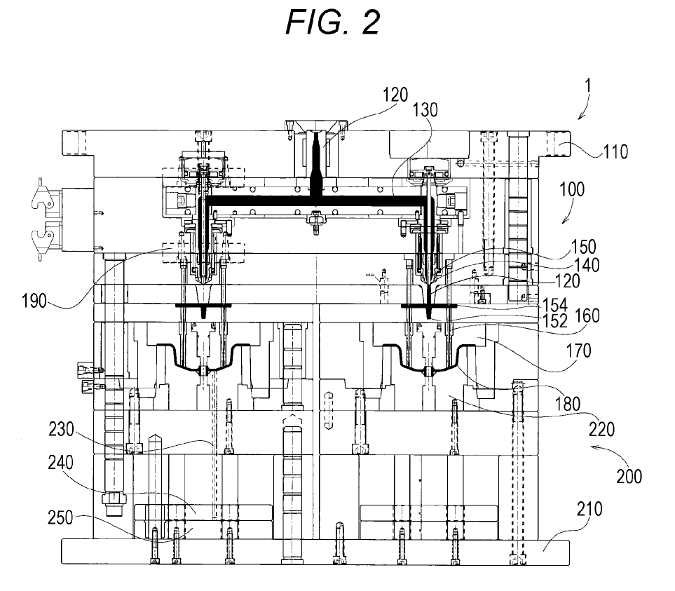

In a dividing step 10, a molten resin material from a spool 120 of an injection apparatus is divided into a plurality of portions through a plurality of equal-length runners. The molten resin material supplied from the dividing step 10 is supplied to a hot runner system. It is noted that FIGS. 2 to 5 illustrate an example of two-cavity molding. Therefore, the runners with equal lengths centered at the spool 120 are a straight line. However, for example, the runners are in three directions at intervals of 120 degrees for three-cavity molding, and in four directions at intervals of 90 degrees for four-cavity molding.

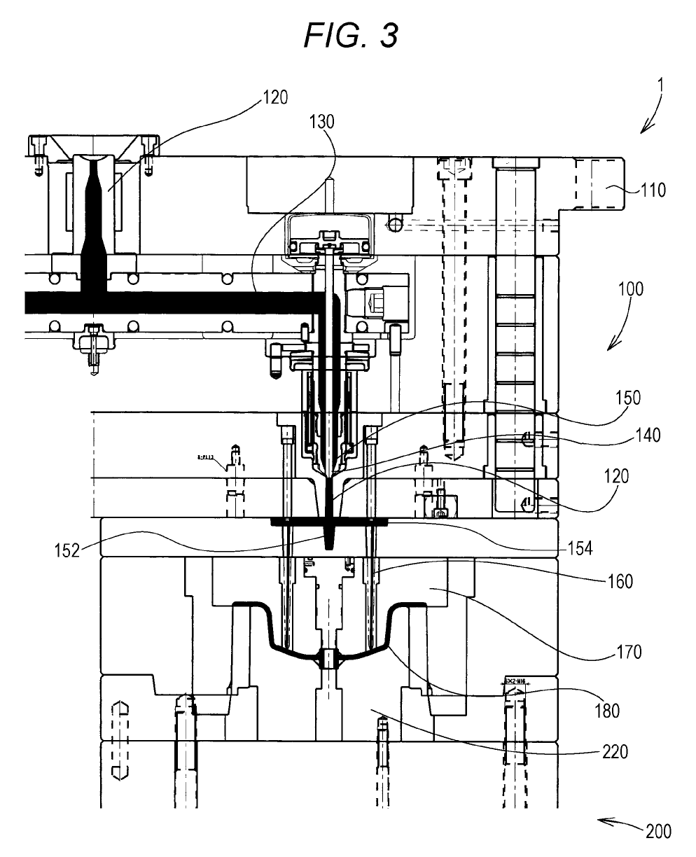

A resin density adjustment step 20 is a step of adjusting the distribution of the resin density of the molten resin material. The resin density adjustment step 20 includes both a hot runner step 22 and a cold runner step 24. The hot runner 150 and the cold runner 160 are connected via a branch runner 154. It is noted that the branch runner 154 is a runner radially extending with a hot runner nozzle 140 located in the center thereof. The branch runner 154 illustrated in FIGS. 2 and 3 is an example in which the cold runner 160 is regularly arranged at six locations on the same pitch circle having its center at the axial center of a fan which becomes a molded product. It is noted that the leading end of the runner is desirably disposed with a slug well 152.

In the hot runner step 22, the resin which has been heated in an injection apparatus to become in a molten state is heated again immediately before being filled into a cavity 180. The hot runner step 22 is used as the first method for achieving good fluidity thereby to obtain uniform resin density. Also, it is desirable to use a common heater or the like for heating by a manifold 190 so that a stable molten state is retained. It is noted that the hot runner nozzle 140 is either an open gate type in which the leading end of the nozzle is opened and recovered or a valve gate type in which an open-close mechanism is provided, and is not limited to either. However, the cutting of the gate is better by the valve gate type which has the open-close mechanism of the gate. The valve gate-type mold is somewhat expensive, but the temperature of the gate portion can be set more easily than the open gate-type mold. Therefore, the valve gate type as illustrated in FIG. 2 is desirable for a rotation fan or the like which is involved in the problem of the invention of the present application.

The cold runner step 24 is carried out for adjusting the flow rate and pressure of the molten resin material having been heated to high temperature by the hot runner nozzle 140 when the resin material is filled into the cavity 180. Especially, for example, when a molded product includes an extraordinarily thin flow portion like a blade portion of a sirocco fan, excessively increased fluidity causes the filling speed into such a narrow channel to increase. Then, molecules constituting the resin are stretched in the flow direction, causing a phenomenon of flow orientation or molecular orientation in which the molecules are arranged in the flow direction.

This leads to problems such as residual stress. Therefore, taking advantages of the hot runner 150 in the previous step, there is adopted a configuration in which the cold runner 160 is used in combination such that the flow properties of the molten resin is adjusted by physical interaction between the temperature difference in the flow channel from the high-temperature region to the low-temperature region and the pressure difference due to the throttle in the cold runner 160.

A filling step 30 is the step of filling the molten resin material having been subjected to resin density adjustment by the resin density adjustment step 20, from a predetermined position of each cavity 180 from an isometric position. It is noted that various arrangement configurations were reviewed by experiment. As a result, when such an arrangement is six equal parts, particularly favorable uniform resin density was obtained.

It is noted that a subsequent cooling step is commonly-practiced air cooling by air, water cooling by cooling water, or the like. A mold releasing step is a similar to a typical step, such as extrusion with an extruding pin 230, extruding plates 240 and 250, and the like. Therefore, a subsequent cooling step is omitted.

FIG. 2 is a front view of an example of two-cavity molding when a molded product is a sirocco fan. The feature of this example is that the hot runner 150 and the cold runner 160 are used in combination. The hot runner 150 and the cold runner 160 are arranged in series as illustrated in the drawing. The molten resin having been adjusted in temperature is adjusted in pressure by a predetermined throttle. This causes the resin to be filled into the shape of a substantially cylindrical fan with uniform speed and properties. It is noted that when the molten resin supplied from the injection apparatus is excessively heated to high temperature, thermal degradation is generally caused. This thermal degradation causes distortion and residual stress to be generated. Therefore, typically, when the runner which flows out from a set upper limit of the temperature is long, the temperature significantly changes, thereby causing such harmful effects in some cases. Also, when the hot runner 150 is used, a waste runner does not remain. Therefore, the use of the hot runner 150 is economical. However, in the invention of the present application, the adjustment of filling speed and pressure by the cold runner 160 has priority over the advantage of the hot runner 150. Therefore, the configuration the cold runner 160 in which the runner remains is used in combination on purpose. More specifically, the molten resin material which has been heated by the injection apparatus to obtain fluidity is heated again by the hot runner nozzle 140 upstream from the cavity. When this further increases the fluidity of the molten resin material, the flow rate of the molten resin material increases in a thin channel of a blade portion. As a result, the above-described harmful effects are caused. To address these harmful effects, the nozzle portion of the cold runner 160 and the flow channel of the cold runner 160 are throttled to adjust the pressure and also to achieve uniform flow rates. Furthermore, it is desirable that a plurality of pin gates is provided so that the flow rates are further adjusted to ensure favorable flow states.

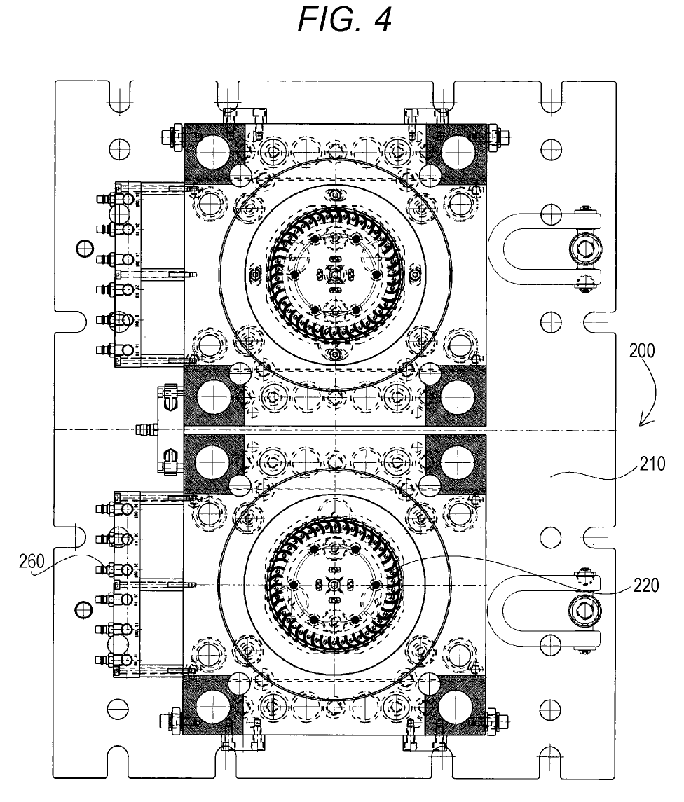

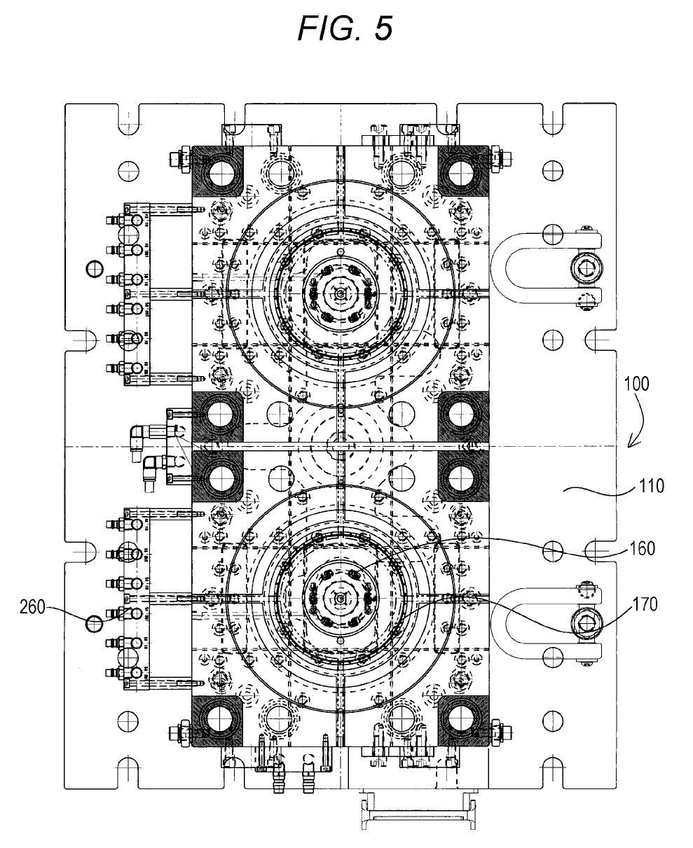

FIG. 2 is a side view illustrating a configuration of two-cavity molding for a sirocco fan. FIG. 3 is an enlarged view illustrating flow channels of a molten resin material. FIG. 4 is a movable-side plan view in the case of two-cavity molding which corresponds to FIG. 2, and FIG. 5 is a fixed-side bottom view in the case of two-cavity molding which corresponds to FIG. 2. Each drawing illustrates an example for a sirocco fan. This sirocco fan is used for air conditioning of an automobile. The blade of the molded product is thin, and the number of blades is as many as 30 to 60. Therefore, this molded product is required to have a uniform resin density distribution.

The present inventor has also conducted experiments with various types such as a propeller fan, a turbofan, and a blower fan, other than the sirocco fan. The temperature control of the hot runner 150, the channel diameter, throttle, nozzle shape, or presence or absence of the gate of the cold runner 160, and the like are prepared in such a manner as to be selectable for any type. Thus, it has been found that a favorable result can be obtained when any fan type is subjected to multi-cavity molding.

It is noted that a mold 1 does not have a particular structure. The mold 1 may be a typically used two-plate or three-plate mold as illustrated in FIGS. 2 to 5. A movable-side mold includes a male mold 220, and a fixed-side mold 100 includes a female mold 170. Also, FIG. 5 illustrates that the leading end of the cold runner 160 is disposed at six locations isotropically from the axial center of the cavity 180. However, the number of leading ends and the positions of the leading ends are not limited. In principle, the number of leading ends can be changed according to the adjustment of pressure and flow rates. It is noted that in the case of the sirocco fan illustrated in the drawing, a sirocco fan supplied from the six locations was physically excellent. Therefore, this is indicated as an example.

The hot runner 150 system is a system which heats a molten resin material supplied from a spool through equal-length runners again to increase fluidity, as illustrated in FIGS. 2 and 3. The hot runner nozzle 140 and the manifold 190 are disposed to the fixed-side mold 100. The hot runner nozzle 140 may be any typically-used nozzle as long as it electrically controls and heats a heater disposed therein. As described above, the hot runner nozzle 140 is either an open gate type in which the leading end of the nozzle is opened and recovered or a valve gate type in which an open-close mechanism is provided, and is not limited to either. However, in the valve gate type which has the open-close mechanism, the cutting of the gate is better, and therefore, the setting of the temperature in the gate portion is easier. For this reason, the valve gate type is desirable for a rotation fan or the like which is involved in the problem of the invention of the present application.

1. A method of multi-cavity injection molding for enabling multi-cavity molding of injection molded products required to have sophisticated resin density distribution, comprising:
a dividing step of dividing a molten resin material from an injection apparatus into a plurality of portions through a plurality of equal-length runners;
a resin density adjustment step of adjusting a resin density distribution of the molten resin material divided into each portion in the dividing step; and
a filling step of filling the molten resin material having a resin density which has been adjusted in the resin density adjustment step into a region where the molten resin material is formed into a molded product, wherein
the resin density adjustment step includes a combined-use step in which both a hot runner step of readjusting a temperature of the molten resin material to adjust fluidity and a cold runner step of adjusting pressure and speed are used in combination,
the combined-use step is dividing the molten resin material from a hot runner to a plurality of cold runners through a spool and a branch runner, and
a plurality of series of steps from the dividing step to the filling step is performed concurrently in one mold.

2. The method of multi-cavity injection molding according to claim 1, wherein a pin gate format in which a plurality of fillings of the molten resin material from the plurality of cold runners into filling regions is arranged to be dispersed in a regular and evenly spaced manner is employed.

3. A mold for multi-cavity injection molding, the mold being for injection molding used in the method of multi-cavity injection molding according to claim 1, comprising:
a dividing structure dividing a molten resin material from an injection apparatus into a plurality of portions through a plurality of equal-length runners;
a resin density adjustment structure adjusting a resin density distribution of the molten resin material of each portion by division by the dividing structure; and
a filling structure filling the molten resin material having a resin density which has been adjusted by the resin density adjustment structure into a region where the molten resin material is formed into a molded product, wherein
the resin density adjustment structure comprises a combined-use runner structure in which both a hot runner readjusting a temperature of the molten resin material to adjust fluidity and cold runners adjusting pressure and speed are used in combination,
the combined-use runner structure divides the molten resin material from the hot runner to the cold runners through a spool and a branch runner, and
a plurality of series of structures from the dividing structure to the filling structure is provided in one mold, and the plurality of series of structures is concurrently operated.

4. The mold for multi-cavity injection molding according to claim 3, wherein a pin gate structure in which a plurality of fillings of the molten resin material from the cold runners into filling regions is arranged to be dispersed in a regular and evenly spaced manner is employed.

5. A mold for multi-cavity injection molding, the mold being for injection molding used in the method of multi-cavity injection molding according to claim 2, comprising:
a dividing structure dividing a molten resin material from an injection apparatus into a plurality of portions through a plurality of equal-length runners;
a resin density adjustment structure adjusting a resin density distribution of the molten resin material of each portion by division by the dividing structure; and
a filling structure filling the molten resin material having a resin density which has been adjusted by the resin density adjustment structure into a region where the molten resin material is formed into a molded product, wherein
the resin density adjustment structure comprises a combined-use runner structure in which both a hot runner for readjusting a temperature of the molten resin material to adjust fluidity and cold runners for adjusting pressure and speed are used in combination,
the combined-use structure divides the molten resin material from the hot runner to the cold runners through a spool and a branch runner, and
a plurality of series of structures from the dividing structure to the filling structure is provided in one mold, and the plurality of series of structures is concurrently operated.

6. The mold for multi-cavity injection molding according to claim 5, wherein a pin gate structure in which a plurality of fillings of the molten resin material from the cold runners into filling regions is arranged to be dispersed in a regular and evenly spaced manner is employed.
